(19) United States
(12) Patent Application Publication
(10) Pub. No.: US 2024/0019901 A1
(43) Pub. Date: Jan. 18, 2024

(54) SPRING-LOADED, UNFOLDING-DISPLAY MOBILE ELECTRONIC DEVICE

(71) Applicant: Michael J Ure, Holladay, UT (US)

(72) Inventor: Michael J Ure, Holladay, UT (US)

(21) Appl. No.: 17/639,456

(22) PCT Filed: Sep. 3, 2020
(86) PCT No.: PCT/US2020/049233

§ 371 Date: Mar. 1, 2023

(51) Int. Cl. G06F 1/16

(52) U.S. Cl. CPC G06F 1/1652; G06F 1/1681; G06F 1/1679; G06F 1/1677; G06F 1/1686; G06F 1/1624; H04M 1/0268

(57) ABSTRACT

A spring-loaded, unfolding-display mobile electronic device enables a display size to be multiplied, for example three-fold. The expanded display is well-suited for viewing of video content, access to which will become more ubiquitous with the adoption of 5G cellular service. In one embodiment, the mobile electronic device is self-unfolding. Gas springs (101A, 101B) may be used that provide desirable damping and locking features. The mobile electronic device may be held face-down and the sides double-pushed together (603). Springs unlock and the folding display self-unfolds (605). In another embodiment, the device senses when it is held face-down (703) and electronically unlocks the springs for self-unfolding.

### BACKGROUND

A three-fold mobile electronic device is described in U.S. Patent Publication 20120307423, entitled Flexible Display Flexural Assembly, published Dec. 6, 2012, incorporated herein by reference. Of particular interest is FIG. 4 thereof. Further improvements to a device of this type are desired.

### BRIEF DESCRIPTION OF THE DRAWING FIGURES

The present invention may be understood with reference to the appended drawing figures. In the drawing:

FIG. 1 is a front view of a folding mobile electronic device.

FIG. 2 is an end view of the device of FIG. 1.

FIG. 3 is a front view of the device of FIG. 1 in an unfolded state.

FIG. 4 is a rear view of the device of FIG. 3.

FIG. 5 is an end view of the device of FIG. 3.

FIG. 6 is a flowchart of a self-unfolding operation.

FIG. 7 is a flowchart of another self-unfolding operation.

FIG. 8 is a front view of another folding mobile electronic device.

FIG. 9 is a flowchart of picture taking using a device like that of FIG. 8.

FIG. 10 is a diagram of a modular mobile electronic device.

FIG. 11 is another diagram of the modular mobile electronic device of FIG. 10.

FIG. 12 is a front view of the modular mobile electronic device of FIG. 11.

### DETAILED DESCRIPTION

### Summary

A spring-loaded, unfolding-display mobile electronic device enables a display size to be multiplied, for example three-fold. The expanded display is well-suited for viewing of video content, access to which will become more ubiquitous with the adoption of 5G cellular service. In one embodiment, the mobile electronic device is self-unfolding. Gas springs may be used that provide desirable damping and locking features. The mobile electronic device may be held face-down and the sides double-pushed together. Springs unlock and the folding display self-unfolds. In another embodiment, the device senses when it is held face-down and electronically unlocks the springs for self-unfolding.

In one aspect, a mobile electronic device includes a main body housing a main processor, a display extension member, a hinge mechanism coupled to the first display extension member and the main body; and a flexible display coupled to the main body and the display extension member. The screen extension member may be configured to: in a folded state, wrap around the main body and overlap the main body at a backside of the main body with a display side of the flexible display facing away from the main body; and in an unfolded state, support the flexible display in an unfolded, flat state. The hinge mechanism comprises a spring-action member and is configured to, during unfolding, move outwardly away from a side of the main body to take up slack of the flexible display created during unfolding.

In another aspect, a mobile electronic device includes a main body housing a main processor, a first display extension member, and a first hinge mechanism coupled to the first display extension member and the main body. The mobile electronic device further comprises a second display extension member, a second hinge mechanism coupled to the second display extension member and the main body, and a flexible display coupled to the main body, the first display extension member and the second display extension member. The first and second screen extension members may be configured to: in a folded state, wrap around the main body and overlap at a backside of the main body with a display side of the flexible display facing away from the main body, and in an unfolded state, support the flexible display in an unfolded, flat state. The first and second hinge mechanisms may each comprise a spring-action member and may be configured to, during unfolding, move outwardly away from respective sides of the main body to take up slack of the flexible display created during unfolding.

In another aspect, a method is provided of expanding the display of a mobile electronic device that includes a main body, a display that folds and unfolds, and a screen extension. In accordance with the method, a user holds the mobile electronic device face down and performs a manual action on the device to initiate unfolding of the display. In response to the manual action, a spring causes the screen extension to unfold and extend away from an edge of the main body such that a front-facing display size is increased.

In another aspect, a method is provided of expanding the display of a mobile electronic device that includes a main body, a display that folds and unfolds, and a screen extension. In accordance with the method, a user turns the mobile electronic device face-down. the mobile electronic device senses the turning, and in response to the turning, the mobile electronic device releasing a spring, causing the screen extension to unfold and extend away from an edge of the main body such that a front-facing display size is increased.

In another aspect, a mobile electronic device includes a main body, a screen extension, a display that folds and unfolds coupled to the main body and to the screen extension, and a hinge mechanism coupled to the main body and to the screen extension. The mobile electronic devices further includes a forward-facing camera module housed within the main body, wherein, in a folded state, a portion of the display is rear-facing and operative to display information to a user, the mobile electronic device being configured to take a rear-facing picture by turning the camera module to be rear-facing and using the rear-facing portion of the display for view finding and camera control.

In another aspect, a method is provided of taking a picture using a mobile electronic device including a unitary folding display and including only a front-facing camera. In accordance with the method, a user turns the camera to be rear-facing and uses what was a rear-facing portion of the folding display for view finding and camera control to take a rear-facing picture.

In another aspect, a self-unfolding mobile electronic device includes a main body, a folding display that, in a folded state, wraps around the main body to overlap the back of the main body, an assembly including a screen extension and a hinge mechanism, and at least one spring mechanism having a damping feature and a locking feature. During self-unfolding, a locking feature of the spring mechanism is released, causing motion of the screen extension such that a front-facing display size is increased. The at least one spring mechanism may include a gas spring. The locking feature of the spring mechanism may be manually controlled. Alternatively, the locking feature of the spring mechanism may be electronically controlled.

In another aspect, a method is provided of performing self-unfolding of a mobile electronic device having a main body, a folding display, an assembly including a screen extension and a hinge mechanism, and at least one spring mechanism having a damping feature and a locking feature. In accordance with the method, a user positions the device face down and applies a pressure input to the device to release a locking feature of the spring mechanism. The screen extension is moved by the at least one spring mechanism such that a front-facing display size is increased.

In another aspect, a method is provided of performing self-unfolding of a mobile electronic device having a main body, a folding display, an assembly including a screen extension and a hinge mechanism, and at least one spring mechanism having a damping feature and a locking feature. In accordance with the method a user positions the device face-down. The device senses motion and positioning of the device and in response releases a locking feature of the spring mechanism. The screen extension is moved by the at least one spring mechanism such that a front-facing display size is increased.

In another aspect, a modular mobile electronic device includes a main body module; a folding display module including a flexible display; and one or more connectors for connecting the main body module and the folding display module. The folding display module is configured such that: in a folded state, the flexible display overlaps the main body at a backside of the main body with a display side of the flexible display facing away from the main body; and in an unfolded state, the flexible display is supported in an unfolded, flat state. The folding display module may include at least one camera.

### DESCRIPTION

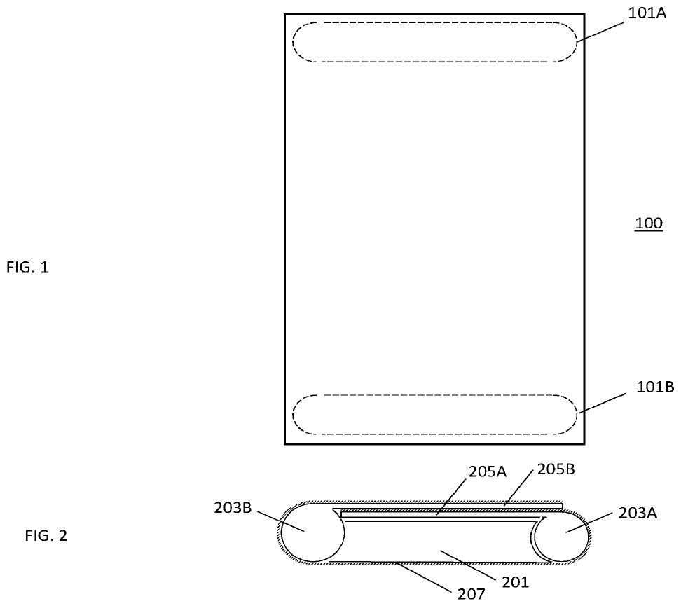

Referring now to FIG. 1, a front view is shown of a spring-loaded, unfolding-display mobile electronic device 100 in a folded state. In the illustrated embodiment, the mobile electronic device is a “three-fold, out-fold” device provided with a flexible touch display of a known type. When the mobile electronic device is unfolded, the display area is increased three-fold. The mobile electronic device is configured such the display folds outwardly like a scroll (instead of inwardly like a book).

Within a main body of the mobile electronic device, springs (101A, 1018) are provided. In some embodiments, a single spring may be provided.

An end view of the mobile electronic device of FIG. 1 is shown in FIG. 2. A main body 201 is adjoined on either side by an assembly that includes a hinge mechanism (203A, 203B) and a screen extension member (“screen extension,” 205A, 205B). The screen extensions provide support for a portion of the display that folds and unfolds. In the folded state as shown, the screen extensions overlap at the back of the main body. The foldable display 207 is supported in the front of the mobile electronic device by the main body, wraps around the hinge members, and overlaps at the back of the main body, supported by the overlapping screen extensions. In this configuration, an active display side of the foldable display is both front-facing and rear-facing.

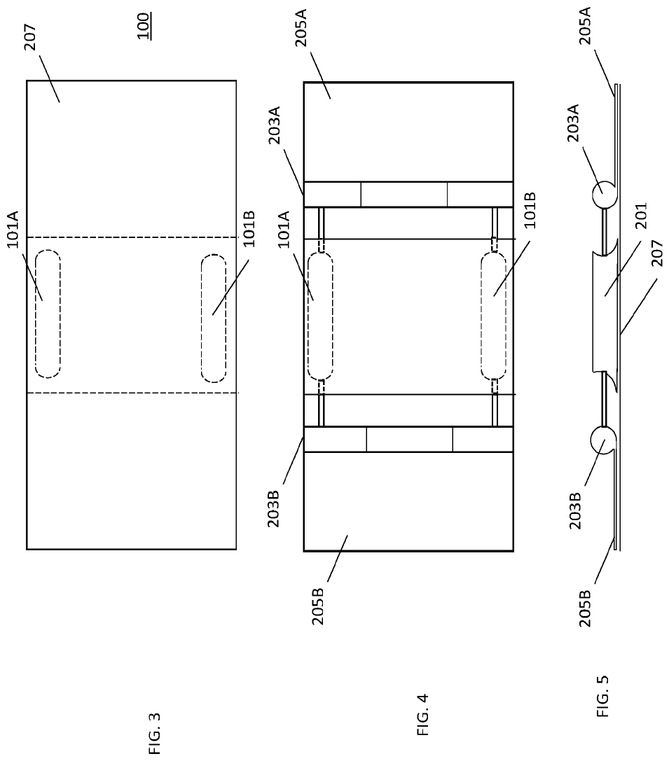

A front view of the mobile electronic device of FIG. 1 in an unfolded state is shown in FIG. 3. Although dashed lines are used to indicate the three-fold increase in display area, the foldable display 207 is continuous and uninterrupted.

A rear view of the mobile electronic device of FIG. 1 in an unfolded state is shown in FIG. 4. In the unfolded state, assemblies 203A/205A and 203B/205B are arranged such that the screen extensions (205A, 205B), instead of overlapping at the back of the main body, are extended outward within a plane defined by the front of the main body 201. The hinge mechanisms (203A, 203B) are supported by rods and are spaced apart from the main body 201 by a distance to take up slack in the display that occurs during unfolding. During unfolding, the hinge mechanisms gradually move away from the sides of the main body to assume a final position shown in FIG. 4.

In one embodiment, the springs may be bi-directional gas springs provided with damping and locking features. In a locked state, the rods are held within a cylinder. When the locked state is released, the rods are forced outward with a damped motion. Unlocking of a rod may occur by a small push or “double push” on the rod. Springs of this type are available, for example, from HXL Gas Springs Company of Xiamen, Fujian, People's Republic of China.

In other embodiments, unlocking occurs electronically. An electric current is applied to an element within the cylinder that expands or contracts in such a way as to release the lock.

In other embodiments, the springs may be wound springs, or other types of springs.

The mobile electronic device of FIGS. 1-5 may be “self-unfolding,” as presently described.

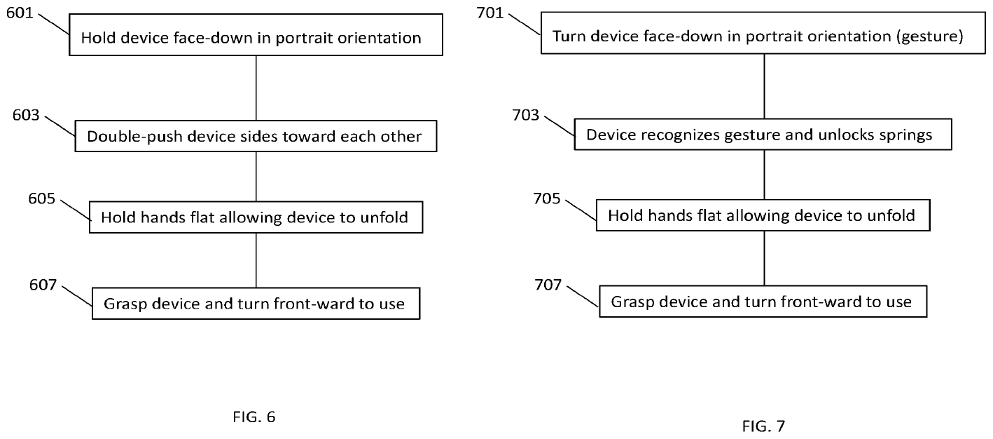

Referring to FIG. 6, in accordance with one aspect, the device is held face-down in portrait orientation (601). The user then double-pushes the device sides toward each other (603). The user then hold his or her hands flat, allowing device to unfold (605). In response to the double-push, the rods of the gas springs are released and extend in a damped manner until the device is fully unfolded. The user then grasps the device and turns it frontward to use (607).

Alternatively, “self-unfolding” may be controlled electronically. Referring to FIG. 7, in accordance with one aspect, the user turns the device face-down in portrait orientation (701). This placing of the device constitutes a motion gesture that is recognized by the device. The device recognizes gesture and unlocks the springs (703). The user then holds his or her hands flat, allowing device to unfold (705). In response to the unlocking, the rods of the gas springs are released and extend in a damped manner until the device is fully unfolded. The user then grasps the device and turns it frontward to use (707).

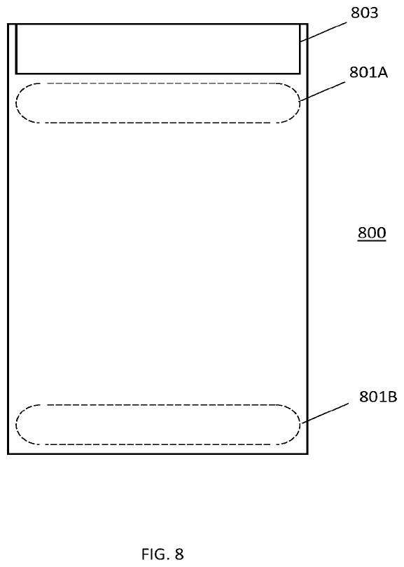

Referring to FIG. 8, a mobile electronic device 800 in accordance with another aspect is shown. The device may be provided with a camera module 803. The camera module 803 may incorporate some or all of the cameras found in a state-of-the-art smartphone. In particular, the camera module may incorporate cameras that in a state-of-the-art smartphone may be rear-facing. Making the cameras instead be front-facing avoids interference by the folding display.

The device may be provided with springs 801A and 801B, similar to the device of FIG. 1. Signals from the camera module 803 may be routed around the spring 801A.

The camera module 803 may include, along a top surface thereof, speakers, mics, buttons, ports, etc., as desired. The camera module 803 may also include antennas.

In some instances, the same camera module 803 may be used for taking forward-facing and rear-facing photos. If the camera is a variable-focus camera, the device may sense the orientation of the device (forward-facing or rear-facing) and adjust focus accordingly.

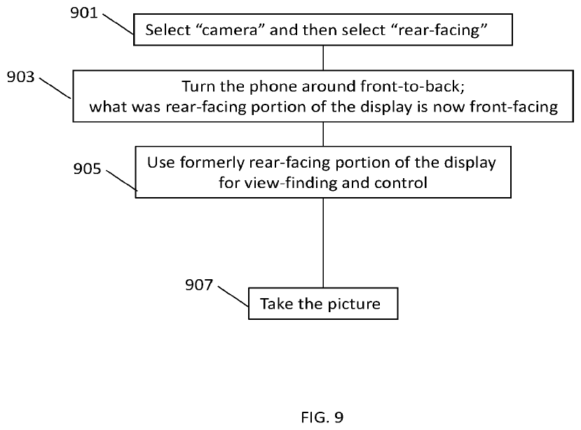

Referring to FIG. 9, to take a rear-facing picture, the user uses the touch display to select “camera” and then select “rear-facing” (901). The user turns the phone around such that the normally front-facing camera module is now rear-facing (903). What was the rear-facing portion of the display is now front-facing and is activated for view-finding and control (905). The user then takes the picture in the usual fashion (907).

In some instances, a separate rear-facing camera module, of more advanced capabilities, may also be provided, with the camera being covered when the display is folded. During unfolding of the display, the camera may be activated by default for ready photo-taking. Switching between portrait and landscape orientations may be performed by touch input or gesture without changing orientation of the device.

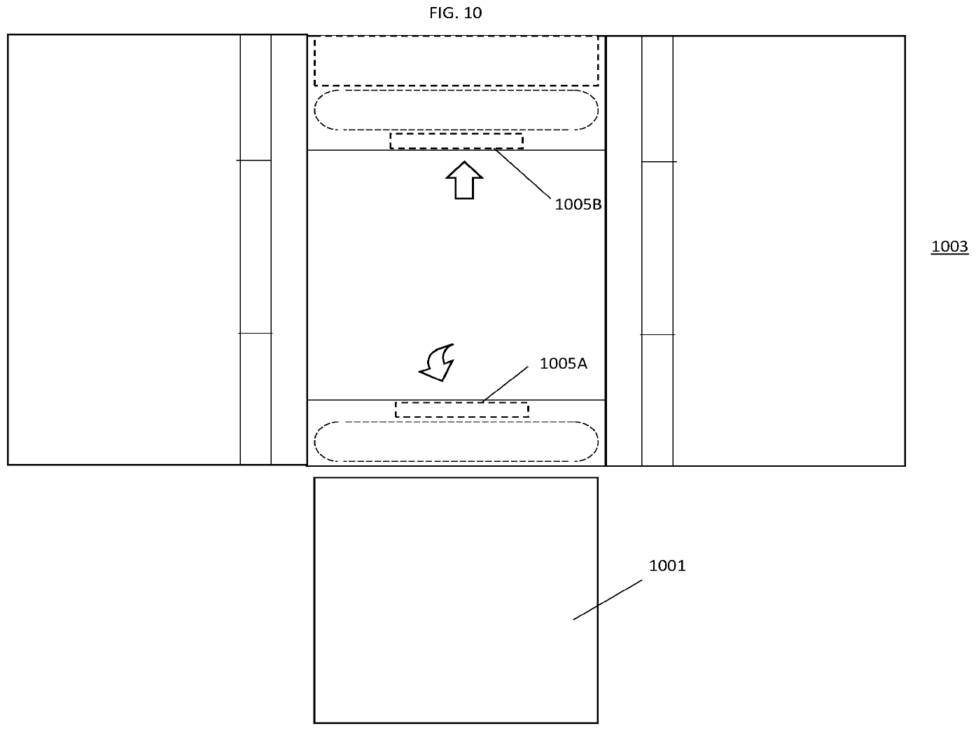

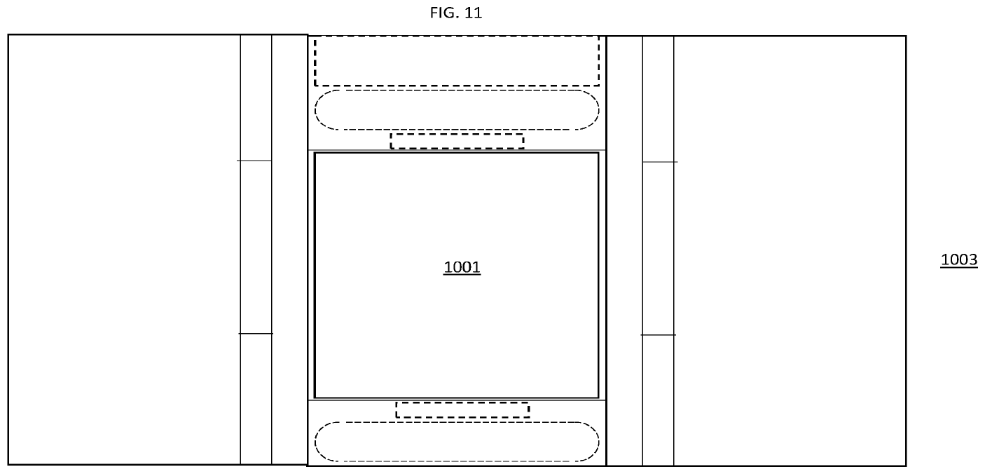

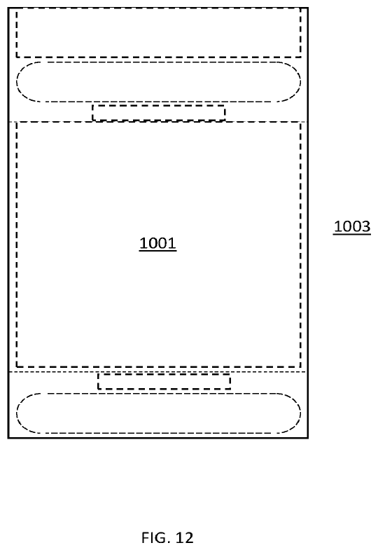

Referring to FIG. 10, a rear, unfolded view is shown of a modular mobile electronic device. One module 1001 may be a main body including a main processor. Another module 1003 may be a folding screen module. The folding screen module may include screen extensions, hinge mechanisms, and springs arranged largely as in embodiments previously described. The folding screen module may also include a camera module as described in relation to FIG. 9. The folding screen module may also include snap-in connectors 1005A and 1005B. The main body 1001 may include complementary snap-in connectors enabling it to snap into the folding screen module. FIG. 11 shows the mobile electronic device with the main body snapped in. In case of damage to either module, it may be easily replaced. The damaged module may be sent for repair. The main body may be made water-proof to a greater degree than may be possible in the case of a fully integrated device. FIG. 12 shows a front view of the device of FIG. 11.

It will be appreciated by those skilled in the art the present invention may be embodied in other specific forms without departing from the spirit or essential character thereof. The foregoing description is therefore intended in all respects to be illustrative and not restrictive. The scope of the invention is indicated by the appended claims, not the foregoing description, and all changes that come within the meaning and range of equivalents thereof are intended to be embraced therein.

1. A self-unfolding mobile electronic device, comprising:
a main body;
a folding display that, in a folded state, wraps around the main body to overlap the back of the main body;
an assembly comprising a screen extension and a hinge mechanism; and
at least one spring mechanism having a damping feature and a locking feature;
wherein, during self-unfolding, a locking feature of the spring mechanism is released, causing motion of the screen extension such that display size is increased.

2. The device of claim 1, wherein the at least one spring mechanism comprises a gas spring.

3. The device of claim 1, wherein the locking feature of the spring mechanism is manually controlled.

4. The device of claim 1, wherein the locking feature of the spring mechanism is electronically controlled.

5. A mobile electronic device comprising:
a main body housing a main processor;
a display extension member;
a hinge mechanism coupled to the first display extension member and the main body; and
a flexible display coupled to the main body and the display extension member;
wherein screen extension member is configured to:
in a folded state, overlap the main body at a backside of the main body with a display side of the flexible display facing away from the main body; and
in an unfolded state, support the flexible display in an unfolded, flat state; and
wherein the hinge mechanism comprises a spring-action member and is configured to, during unfolding, move outwardly away from a side of the main body to take up slack of the flexible display created during unfolding.

6. A mobile electronic device comprising:
a main body housing a main processor;
a first display extension member;
a first hinge mechanism coupled to the first display extension member and the main body;
a second display extension member;
a second hinge mechanism coupled to the second display extension member and the main body; and
a flexible display coupled to the main body, the first display extension member and the second display extension member;
wherein the first and second screen extension members are configured to:
in a folded state, overlap at a backside of the main body with a display side of the flexible display facing away from the main body; and
in an unfolded state, support the flexible display in an unfolded, flat state; and
wherein the first and second hinge mechanisms each comprise a spring-action member and are configured to, during unfolding, move outwardly away from respective sides of the main body to take up slack of the flexible display created during unfolding.

7. A method of expanding the display of a mobile electronic device comprising a main body, a display that folds and unfolds, and a screen extension, the method comprising:
a user:
holding the mobile electronic device face down; and
performing a manual action on the device to initiate unfolding of the display; and
in response to the manual action, a spring causing the screen extension to unfold and extend away from an edge of the main body.

7.-14. (canceled)
